(19) United States
(12) Patent Application Publication
(10) Pub. No.: US 2024/0243579 A1
(43) Pub. Date: Jul. 18, 2024

(54) MANAGEMENT SYSTEM OF POWER GRID AND CALCULATION DEVICE

(71) Applicant: Toyota Jidosha Kabushiki Kaisha, Toyota-shi (JP)

(72) Inventors: Junichi MORI, Nagakute-shi (JP); Yushi SEKI, Ashigarakami-gun (JP); Yuta OGAWA, Yokohama-shi (JP)

(73) Assignee: Toyota Jidosha Kabushiki Kaisha, Toyota-shi (JP)

(21) Appl. No.: 18/485,425

(22) Filed: Oct. 12, 2023

(30) Foreign Application Priority Data
Jan. 12, 2023 (JP) 2023-002968

(51) Int. Cl. H02J 3/32; H02J 3/00

(52) U.S. Cl. CPC H02J 3/32; H02J 3/003

(57) ABSTRACT

In a power grid management system in which a plurality of power generation facilities, a storage battery BT capable of storing electric power generated by the plurality of power generation facilities, and a load capable of using electric power from the plurality of power generation facilities and the storage battery are connected, a storage battery CO2 emission factor unit for calculating a CO2 emission factor of the storage battery is configured to calculate a CO2 emission factor of the storage battery based on a CO2 emission factor of a power generation facility that generates electric power charged in the storage battery among the plurality of power generation facilities and an electric power quantity charged in the storage battery.

### CROSS-REFERENCE TO RELATED APPLICATION

This application claims priority to Japanese Patent Application No. 2023-002968 filed on Jan. 12, 2023 incorporated herein by reference in its entirety.

### BACKGROUND

### 1. Technical Field

The present disclosure relates to a calculation device and a power grid in which electric power is transferred among a power generation facility, a load, and a storage battery, and more particularly, to a system that controls carbon dioxide (CO2) emitted when electric power is generated.

### 2. Description of Related Art

In order to prevent global warming and to achieve decarbonization, various configurations have been proposed for generating electric power while minimizing CO2 emissions. For example, WO2020/230276 proposes a configuration in which a simulation of a power supply plan of a power system for a customer facility is performed, and the reduction amount of the cost or CO2 emissions due to the power supply when the storage battery of the automobile is introduced into the customer facility is calculated. The simulation is performed based on a temporal change in the amount of power used by the customer facility, the contract details of the cost or the amount of CO2 emissions due to the power supply of the power system to the customer facility (including information on the CO2 intensity), a plan for connecting a storage battery of an automobile having a storage battery to the customer facility, and the specifications of the storage battery, and a temporal change in the amount of electric power of the power system supplied to the customer facility. Japanese Unexamined Patent Application Publication No. 2018-186607 (JP 2018-186607 A) proposes, in a configuration in which storage batteries storing electric power generated by the power generation facilities of a plurality of consumers are each capable of supplying power to the power system, a configuration in which a higher priority is given as the emission amount of CO2 emitted when electric power to be stored in the storage battery of each customer is created is lower, and which allows discharging from the storage battery of the customer with the higher priority to the power system. Japanese Unexamined Patent Application Publication No. 2013-158153 (JP 2013-158153 A) proposes, in a power grid network having a plurality of power stations and substations and a plurality of storage batteries attached thereto, a configuration in which the power generation amount of a power station and storage battery selected in the ascending order of the power generation unit representing the environmental load, such as the amount of CO2 emissions per unit electric power amount is added up until a demand amount is obtained. Japanese Unexamined Patent Application Publication (Translation of PCT Application) No. 2022-510390 (JP 2022-510390 A) proposes, in a power distribution network to which the batteries of a plurality of electrified vehicles are connected, a configuration for reducing the amount of CO2 emissions in the network by charging the batteries of electrified vehicles when the amount of CO2 emissions of a power generation source is low. Japanese Unexamined Patent Application Publication No. 2013-110881 (JP 2013-110881 A) proposes power management in a residential system capable of power transmission between a house equipped with a photovoltaic power generation facility and the storage battery of an electrified vehicle. In the management, in order that the electrified vehicle is charged by the photovoltaic power generation facility without substantially using the system power, when the storage battery of the electrified vehicle is charged with electric power from the system power, the amount of CO2 emitted at the time of generating the electric power is accumulated as a count value, when electric power is discharged from the storage battery of the electrified vehicle to the house, the subtraction is performed on the counter value in accordance with the discharging amount, and when the electrified vehicle with a storage battery in which electric power is accumulated is connected to the house, the electric power is discharged from the storage battery to the house until the count value reaches 0.

### SUMMARY

As the CO2 emission factor of the power generation facility (the amount of CO2 emitted as a result of the power generation of the unit electric power amount) varies, it is preferable that the power from the power generation facility having a smaller CO2 emission factor be selectively used in order to suppress as much as possible the CO2 emission amount associated with the power generation of the electric power amount when the electric power consumer uses the electric power. Incidentally, in a power grid in which various power generation facilities including a thermal power generation facility that uses fossil fuels, and a renewable energy power generation facility such as solar power generation and wind power generation are connected, suppose that the amount of electric power generated by each power generation facility is stored in a storage battery, and when the stored electric power is used by a power consumer, that is, when the storage battery is used as a power source similar to the power generation facility, the “CO2 emission factor” (the CO2 emission factor of the storage battery) concerning the storage battery, that is, the amount of CO2 emitted in accordance with the power generation of the unit electric power amount in the amount of electric power stored in the storage battery can be grasped. This is convenient, when the power consumer selects the storage battery as the power source, for the power consumer who intends to suppress as much as possible the amount of CO2 emissions associated with the amount of electric power used by the power consumer. That is, by examining CO2 emission factor of a certain storage battery, when the electric power is used from the storage battery, it becomes easy to estimate how much CO2 is emitted to generate the electric power. With regard to the determination of the “CO2 emission factor of the storage battery”, once the electric power generated by the various power generation facilities in the power grid as described above is stored in the storage battery, the power generation origin of the electric power is indistinguishable when the electric power is extracted from the storage battery, and therefore, the CO2 emission factor of the storage battery cannot be measured even when the extracted electric power (discharged electric power) is referred to. However, when the received electric power from the respective power generation facilities and the CO2 emission factor in the respective power generation facilities are used at the time of the charging of the storage battery, the CO2 emission factor of the storage battery can be determined.

Thus, the main issue of the present disclosure is to provide a configuration for providing a CO2 emission factor of a storage battery in a power grid in which power generation facilities having different CO2 emission factors, a storage battery storing electric power from the power generation facilities, and a load using electric power from the power generation facilities and the storage battery are connected.

According to the present disclosure, the above issue is solved by a management system of a power grid in which a plurality of power generation facilities, a storage battery that is able to store electric power generated by the power generation facilities, and a load that is able to use electric power from the power generation facilities and the storage battery are connected.

The power grid system includes a storage battery CO2 emission factor unit that calculates a CO2 emission factor of the storage battery.
The storage battery CO2 emission factor unit is configured to calculate the CO2 emission factor of the storage battery based on a CO2 emission factor of each of power generation facilities, among the power generation facilities, that generates the electric power charged in the storage battery, and an amount of the electric power charged in the storage battery from each of the power generation facilities.

In the above configuration, the “power generation facility” may be a power generation facility that generates electric power in any manner, and may be a thermal power generation facility that uses fossil fuel, a nuclear power generation facility, a renewable power generation facility such as solar power generation and wind power generation, an on-vehicle power generation facility (a drive unit capable of generating electric power such as a hybrid electric vehicle, fuel cell electric vehicle), and the like. The “storage battery” may be a storage battery commonly used in this field, and may be, for example, a stationary power storage device or a storage battery mounted on an electrified vehicle. A “load” may be any machine instrument that operates using electric power. A “power grid” may be a network of transmission lines that transmit electric power among a power generation facility, a storage battery, and a load in a conventional manner. The “CO2 emission factor of the storage battery” is, as mentioned above, the emission amount per unit-generated electric power amount of CO2 emitted when the amount of electric power stored in the storage battery is generated. As described above, the CO2 emission factor of the storage battery is calculated based on the CO2 emission factor of each of the power generation facilities that generates the electric power charged in the storage battery and the amount of the electric power charged in the storage battery from each of the power generation facilities. The CO2 emission factor of each of the power generation facilities can be known in advance by any method (the amount of CO2 generated in the power generation of the unit electric power amount may be measured by any method). The amount of the electric power from each of the power generation facilities to the storage battery may be measured by any method at the time of charging the storage battery.

According to the above-described configuration of the present disclosure, the CO2 emission factor of the storage battery in which the amount of electric power generated by various power generation facilities is charged, that is, the emission amount per unit electric power amount of CO2 emitted in accordance with the power generation of the amount of electric power stored in the storage battery is calculated. Accordingly, when the power consumer takes out an arbitrary amount of electric power from the storage battery and obtain the amount of electric power, the power consumer easily knows how much CO2 is emitted. In particular, in the present disclosure, even when the storage battery receives electric power from power generation facilities having different CO2 emission factors, the CO2 emission factor of the storage battery is calculated from the CO2 emission factor of each power generation facility and the actual amount of electric power received from each power generation facility, so that the CO2 emission factor of the storage battery can be obtained with higher accuracy (for example, as compared to a case in which the mean of the CO2 emission factors of the respective power generation facilities is used), and thus the CO2 emission amount associated with the power generation of the amount of electric power extracted from the storage battery can be grasped with higher accuracy.

In an embodiment of the above configuration, the CO2 emission amount associated with the power generation of the amount of electric power stored in the storage battery can be regarded as a sum of multiplication values that are each obtained by multiplying the CO2 emission factor of each of the power generation facilities, among the power generation facilities, that generates the electric power charged in the storage battery by the amount of the electric power charged in the storage battery from each of the power generation facilities. Therefore, the CO2 emission factor of the storage battery may be a value obtained by dividing the sum of the multiplication values each obtained by multiplying the CO2 emission factor of such a power generation facility by the amount of the electric power charged in the storage battery by a sum of the amounts of the electric power charged in the storage battery from the respective power generation facilities. Specifically, the current value of the CO2 emission factor of the storage battery is calculated as follows. A value is obtained by adding a CO2 emission amount associated with the power generation of the amount of accumulated electric power (the amount of electric power stored in the storage battery) at a time point that is earlier from the current time point by a predetermined time period, which may be arbitrary set, to a CO2 emission amount associated with the power generation of the amount of electric power charged during the predetermined time period. The obtained value is divided by the amount of accumulated electric power of the present time point, so that (at the time of the discharging of the storage battery, in terms of the amount of electric power taken out from the storage battery, the ratio of the amount of electric power generated by each of the power generation facilities is the same as that at the time of charging, and thus the CO2 emission factor of the storage battery does not change.)

Further, if the power consumer can grasp a CO2 emission factor of the load, that is, the emission amount per unit electric power amount of the CO2 emitted at the time of power generation of the amount of electric power used by the load, the power consumer can easily know the increment of the amount of CO2 emitted at the time of power generation of the amount of electric power used in accordance with the operation of the load. This is convenient when an attempt to reduce the amount of CO2 emitted in accordance with the operation of the load is made. In the management system of the present disclosure, the management system may further include a load CO2 emission factor unit that calculates a CO2 emission factor of the load, and the load CO2 emission factor unit is configured to calculate the CO2 emission factor of the load based on the CO2 emission factor of each of power generation facilities, among the power generation facilities, that supplies electric power to the load, an amount of the electric power supplied to the load from each of the power generation facilities, the CO2 emission factor of the storage battery, and an amount of electric power supplied to the load from the storage battery.

In addition, in the above management system, if the ratio of the origin of power generation of the amount of the electric power stored in the storage battery or the amount of the electric power used by the load, that is, the ratio of the amount of the electric power stored in the storage battery or the amount of the electric power used by the load to the amount of the electric power generated in each of the power generation facilities can be grasped, this is convenient when an attempt to use electric power obtained from a power generation facility having a smaller CO2 emission amount is made. Therefore, in the management system of the present disclosure, the management system may be further provided with a unit that calculates the ratio of the origin of power generation of the amount of the electric power stored in the storage battery or the amount of the electric power used by the load.

In a power grid to which the above management system is applied, a storage battery mounted on an electrified vehicle may be selectively connected so that electric power from the power generation facility is charged and electric power is discharged to the load via the power grid, and at this time the CO2 emission factor of the storage battery may be calculated, or the CO2 emission factor of the load may be calculated using the CO2 emission factor of the storage battery. Therefore, in the above management system, the storage battery may be a storage battery mounted on a vehicle that is selectively connected to the power grid.

The unit that calculates the CO2 emission factor of the storage battery in the above management system may be implemented independently as a device. Thus, the above issue is solved by equipment that is a storage battery CO2 emission factor calculation device that calculates a CO2 emission factor of a storage battery that stores electric power generated by a plurality of power generation facilities, and the equipment is configured to calculate the CO2 emission factor of the storage battery based on a CO2 emission factor of each of the power generation facilities and an amount of electric power charged in the storage battery.

Thus, in the management system of a power grid of the present disclosure, the CO2 emission factor of the storage battery that receives electric power from various power generation facilities is calculated, and the power consumer can grasp how much environmental load per unit electric power amount is applied to obtain the electric power to be extracted from the storage battery. When an attempt to suppress CO2 emission amount as much as possible is made, the power consumer tries to take out electric power from the storage battery with the smallest possible CO2 emission factor, thus it is expected that the suppression of the CO2 emission amount is promoted. Further, since the CO2 emission factor of the storage battery calculated by the system of the present disclosure is calculated based on the CO2 emission factor of each of the power generation facilities that generates the electric power charged in the storage battery, among the plurality of power generation facilities, and the amount of the electric power charged in the storage battery from each of the power generation facilities, even when the electric power from the power generation facilities that differ in CO2 emission factor is charged in the storage battery, the CO2 emission factor of the storage battery can be used as an index representing the CO2 amount emitted per unit electric power amount with high accuracy. That is, the CO2 emission factor of the storage battery of the present disclosure represents the degree of load applied to the environment per unit electric power amount that varies in accordance with the origin of power generation of the electric power charged in the storage battery, and it is considered that the smaller the value, the cleaner the electric power stored in the storage battery. Therefore, the CO2 emission factor of the storage battery can be used as an index for grasping the degree of cleanness of the electric power of the storage battery that varies in accordance with the origin of power generation of the electric power at the time of charging. The configuration of the present disclosure may be applied to a power grid of various scales, such as a house configured to supply electric power (system power) from a commercial power system and electric power from a photovoltaic power generation facility or the like to a storage battery and a load, a power grid of an apartment house, and a power grid covering a region where electric power is supplied from various power generation facilities.

Other objects and advantages of the present disclosure will become apparent from the following description of preferred embodiments of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram of an electric power network to which a control system according to the present embodiment is applied, showing the flow of electric power when the storage battery is charged;

FIG. 1B is a schematic diagram of an electric power network to which a control system according to the present embodiment is applied, showing the flow of electric power during discharging of a storage battery;

FIG. 1C is a diagram schematically illustrating a CO2 quantity discharged in accordance with generation of electric power stored in a storage battery;

FIG. 2 is a block-diagram illustrating a configuration of an arithmetic unit for calculating a CO2 emission factor of a storage battery and a load in the management system according to the present embodiment; and

FIG. 3 is a diagram showing an arithmetic processing in the management system according to the present embodiment in the form of a flowchart.

### DETAILED DESCRIPTION OF EMBODIMENTS

### Configuration of the Power Grid

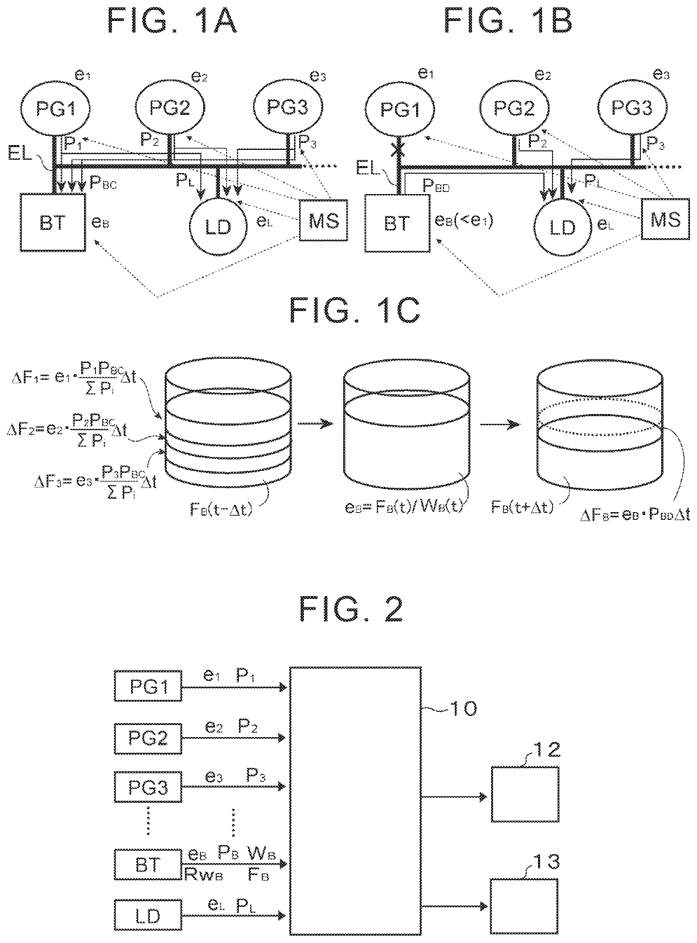

The power grid to which the management system of the present embodiment is applied is configured to be capable of selectively supplying power from the storage battery BT to the load LD by connecting a plurality of power generation facilities PG1, PG2, PG3, . . . and a storage battery BT, load LD to the power transmission line EL, and allowing selectively supplying power from the respective power generation facilities PG1, PG2, PG3 . . . . to the storage battery BT and the load LD, as schematically illustrated in FIGS. 1A and 1B. In such a power grid, the transmission of electric power from the respective power generation facilities PG1 . . . . to each of the storage battery BT and the load LD and the transmission of electric power from the storage battery BT to the load LD may be configured such that the management system MS appropriately controls the condition of the respective power generation facilities PG1 . . . . and the storage battery BT, load LD. The power generation facilities PG1, PG2, PG3, . . . may be an electric power source that generates and outputs electric power in any manner, and may be a facility that generates electric power by various thermal power, nuclear power, hydroelectric power, solar power, wind power, or the like. A commercial power system may be connected to the power grid as a power generation facility. Further, an electrified vehicle equipped with a power generation device such as a hybrid electric vehicle or a fuel cell electric vehicle may be connected as the power generation facility. CO2 emission properties are characterized by e1, e2, e3, . . . of CO2 emission factors, which may be different from each other, since the respective power generation facilities may have different amounts of CO2 emitted per unit-power generation. CO2 emission factors of the respective power generation facilities can be detected by any method. The storage battery BT may be any type of storage battery commonly used in the art, and may be a stationary power storage device or a storage battery mounted on an electrified vehicle. Note that, although not shown, a plurality of storage batteries may be connected to the power grid, and charge and discharge may be performed independently of each other. The load may be any machine instrument that operates using electrical power. Although not shown, a plurality of loads may be connected to the power grid, and power may be used independently of each other. The management system MS may be any type of control device that controls the power transfer between facilities (including power generation facilities, storage batteries, and loads, if simply referred to as “facilities”) via the power transmission line EL, as described above, and may typically be a conventional type of computing device. The configuration and operation of each unit of the management system MS of the present embodiment described later may be realized by the operation of a computer according to a program. The communication between the management system MS and the respective facilities may be performed using any type of communication system, and the operation of the management system MS may be achieved by the operation of the mobile terminal carried by the power consumer.

In the present embodiment, in the power grid management system MS, an arithmetic unit or an arithmetic unit for calculating a CO2 emission factor of a storage battery or a load, a ratio of a power generation source of the power stored in the storage battery, or a ratio of a power generation source of the power used in the load is provided. As shown in FIG. 2, the arithmetic unit 10, which is a unit for calculating CO2 emission factor and the like of the storage battery, may be a computer device, and parameters used in the arithmetic operations described later are inputted. Specifically, CO2 emission factor e₁, . . . , and the output power P₁ . . . . of the power generation facilities PG1 and the like, charge and discharge power P_{B} in the storage battery BT, the electric power storage amount W_{B}, CO2 emission amount F_{B} associated with the power generation of the storage amount, the ratio R_{WB} of the charge and discharge power to the storage power amount, and input power P_{L} in the load LD may be included. Further, the calculation result by the arithmetic unit 10 may be displayed on the display unit 12 in an arbitrary manner that can be recognized by the administrator of the power grid and the power consumer, and may be transmitted to the arbitrary control unit 13 and used for arbitrary control.

### Electricity Flow During Charging and Discharging of Storage Batteries

In the above-described power grid, in a state in which the storage battery BT is charged with electric power, as shown in FIG. 1A, each output power (from the P₁) from a power generation facility selected from the power generation facility PG₁ connected to the power grid is supplied to the storage battery BT and the load LD in use. On the other hand, in a state in which electric power is discharged from the storage battery BT (a state in which electric power is supplied to the load), as shown in FIG. 1B, the output power P_{BD} from the storage battery BT and the output power (from the P₂) from the power generation facility selected from the power generation facility PG₁ are supplied to the load LD in use. Changes in CO2 Emissions from Electricity Storage during Charge/Discharge of Storage

### Batteries

The change in CO2 discharge amount due to the power generation of the storage amount due to the increase or decrease in the storage amount during the charging and discharging of the storage battery BT can be considered as follows. First, the increment of the amount of CO2 discharged due to the power generation of the storage amount during the charging of the storage battery BT is the sum of the increments of the amount of CO2 discharged due to the increment of the amount of power input from each power generation facility to the storage battery BT (ΔF₁, ΔF₂, ΔF₃, . . . ) (see the left-hand side of FIG. 1C). Here, it is considered that the ratio of the electric power amount increment input from each power generation facility to the storage battery BT in the increment of the electric power amount input to the storage battery BT corresponds to the ratio of the electric power output from each power generation facility to the electric power grid to the sum of the electric power output from all power generation facilities to the electric power grid. Therefore, from the incremental amount of CO2 emissions ΔF₁ for each power generation facility, the amount of input power P_{B}Δt to the storage battery BT is multiplied by the ratio of CO2 emission factor of each power generation facility (from e₁) to the ratio of the output power of each power generation facility (from Pᵢ) to the sum of the output power of all power generation facilities (ΣPᵢ) (Δt is a predetermined cycle time, which may be set in units of time or arbitrarily). Then, CO2 discharge amount F_{B}(t) associated with the power generation of the storage amount of the storage battery BT after the charge (at time t) is increased by ΔF₁+ΔF₂+ΔF₃+ . . . . In addition, since the amount of electric power once charged in the storage battery BT is indistinguishable from the power generation source (refer to FIG. 1C), CO2 emission factor of the storage battery, that is, CO2 emission amount per unit electric power amount discharged in accordance with the power generation of the electric storage amount, CB, is given by CO2 emission amount F_{B} in accordance with the power generation of the electric storage amount for the total electric power storage amount W_{B} of the storage battery.

On the other hand, when the storage battery BT is discharged, it is considered that the electric power is discharged without distinguishing the generation origin of the electric power, and there is no change in CO2 emission factor e_{B} of the storage battery (CO2 discharge amount F_{B} is proportional to the total electric power storage amount W_{B} of the storage battery), the reduction in the amount of CO2 discharged due to the reduction in the amount of electric power discharged from the storage battery is obtained by multiplying CO2 emission factor e_{B} of the storage battery by the output electric power amount P_{BD}Δt from the storage battery BT (see the right-hand side of FIG. 1C).

### Calculation of CO2 Emission Factor eB for Storage Batteries

As described above in the summary section, in the power grid management system of the present embodiment, CO2 emission factor e_{B} of the storage battery is calculated by the arithmetic unit. When CO2 emission factor e_{B} of the storage battery is obtained, it is convenient to select a power source from various power generation facilities or storage batteries when the power consumer tries to suppress CO2 emission as much as possible when using the amount of electric power for the load.

In the calculation of CO2 emission factor e_{B} of the storage battery, when the storage battery is charged, the arithmetic unit calculates, as storage battery information, the electric power P_{B}(t) charged from the storage battery BT (<0 when the storage battery is charged, P_{B} sets discharge time to >0), the electric power storage amount W_{B}(t−Δt) before charging and CO2 emission amount F_{B}(t−Δt) associated with the electric power generation of the electric power storage amount before charging are received, and the power generation facility PGᵢ (i is the code of the electric power generation facility, the same shall apply hereinafter) CO2 emission factor eᵢ and the power Pᵢ are received as the power generation information from each power generation facility PGᵢ. Then, the charged electric power storage amount W_{B}(t), CO2 discharge amount F_{B}(t), and CO2 emission factor e_{B}(t) are respectively calculated by the following equations.

$${W}_{B} ( t ) = {W}_{B} ( t - Δ t ) - {P}_{B} ( t ) \cdot Δ t / 3600 \qquad ( 1 a )$$

$${F}_{B} ( t ) = {F}_{B} ( t - Δ t ) - {P}_{B} ( t ) \cdot Δ t / 3 \; 600 \cdot \sum {e}_{i} ( t ) {P}_{i} ( t ) / \sum {P}_{i} ( t ) \qquad ( 1 b )$$

(Σ is the sum of PGᵢ of power generation facilities that are generating electricity.)

$${e}_{B} ( t ) = {F}_{B} ( t ) / {W}_{B} ( t ) \qquad ( 1 c )$$

In the above equation, Pᵢ(t), P_{B}(t), and P_{L}(t) [input power to loads]

$$\sum {P}_{i} ( t ) = - {P}_{B} ( t ) + {P}_{L} ( t ) \qquad ( 1 d )$$

The assumptions are made (and so on).

Further, when the storage battery is discharged, the computing device receives the respective values of the electric power P_{B}(t) (>0), as storage battery information, discharged from the storage battery BT, the electric power storage amount W_{B}(t−Δt) before the discharge, and CO2 discharged amount F_{B}(t−Δt) associated with the generation of the electric power storage amount before the discharge, and calculates the electric power storage amount W_{B}(t) after the discharge, CO2 discharged amount F_{B}(t) by the following equations. As described above, CO2 emission factor e_{B}(t) does not change during discharging.

$${W}_{B} ( t ) = {W}_{B} ( t - Δ t ) - {P}_{B} ( t ) \cdot Δ t / 3600 \qquad ( 2 a )$$

$${F}_{B} ( t ) = {F}_{B} ( t - Δ t ) / ( 1 + {P}_{B} ( t ) \cdot Δ t / {W}_{B} ( t ) / 36 \; 00 ) \qquad ( 2 b )$$

$$Or$$

$${F}_{B} ( t ) = {F}_{B} ( t - Δ t ) - {e}_{B} ( t ) \cdot {P}_{B} ( t ) \cdot Δ t / 3600 \qquad ( 2 b )$$

CO2 emission factor e_{B} of the storage battery is a value obtained by dividing CO2 emission factor that increases as CO2 emission factor of each power generation facility that has generated the charged amount of electric power increases and the charged amount of electric power increases as the total storage amount of electric power is increased, as understood from the derivation equation, so that CO2 emission factor e_{B} is an index of CO2 emission per unit amount of electric power at the time of power generation of the electric power storage amount of electric power, and as CO2 emission factor e_{B} is smaller, CO2 emission amount when the unit amount of electric power is used is smaller, that is, cleaner. Therefore, as described above, when CO2 emission factor e_{B} of the storage battery is obtained, as shown in FIG. 1B, when the electric power is supplied to the load, CO2 emission factor e_{B} of the storage battery is lower than CO2 emission factor (e1, for example) of a certain power generation facility, it is possible to easily grasp that CO2 emission rate of the storage battery can be suppressed by selecting the storage battery as the electric power source, and it is easy to determine that the storage battery is selected as the electric power source instead of the power generation facility having the higher CO2 emission factor. (On the contrary, if CO2 emission factor of the available power generation facility is lower than CO2 emission factor e_{B} of the present storage battery, it can be easily understood that the storage battery should not be selected as the power source at that time.)

As described above, the storage battery may be a storage battery on which an electrified vehicle is mounted. In this case, the on-board storage battery is connected to the power grid. The calculation process of CO2 emission factor e_{B} of the storage battery is the same as that described above. Note that the storage battery equipped with electrified vehicle may be connected as a load of the power grid at the time of charging, and it is easy to determine whether or not to select the storage battery connected to the power grid as a power source at the time of charging the in-vehicle storage battery.

### Calculation of CO2 Emission Factor e_{B} of the Impact

As described above, in the power grid management system of the present embodiment, the calculation device may calculate CO2 emission factor e_{L} of the load, that is, CO2 emission amount per unit electric power amount discharged at the time of power generation of the electric power amount used in the load. Knowing CO2 emission factor e_{B} of the load makes it easy to know the increment of CO2 emitted as the load operates, which is convenient when attempting to reduce CO2 emissions associated with the load operation. In the arithmetic unit, CO2 emission factor e_{L} of the loads may be calculated by the following equation.

$${e}_{L} = \{ \sum {e}_{i} ( t ) {P}_{i} ( t ) + {e}_{B} ( t ) {P}_{B} ( t ) \} / \{ \sum {P}_{i} ( t ) + {P}_{B} ( t ) \} \qquad ( 3 )$$

When calculating CO2 emission factor e_{L}, the respective values of CO2 emission factor eᵢ of the respective power generation facility PGᵢ, the respective values of the output power Pᵢ, and the power P_{B}(t) discharged as the storage battery information from the storage battery BT are inputted to the arithmetic unit from the respective power generation facility PGᵢ as the power generation information.

### Calculation of the Ratio of Electricity Storage and Load Usage to Generation Origin

Further, in the power grid management system of the present embodiment, the ratio of the power generation origin of the storage amount and the load usage amount, that is, the ratio of the amount of electric power generated by each power generation facility in the amount of electric power stored in the storage battery, or further, the ratio of the amount of electric power generated by each power generation facility in the amount of electric power used in the load may be calculated. These findings are useful in contemplating the use of power obtained from power generation facilities with lower CO2 emissions. In the arithmetic device, the ratio of the amount of electric power generated by each power generation facility in the amount of electric power storage may be calculated as follows.

First, the electric power amount W_{B}i(t) generated by the respective power generation facilities i at the electric storage amount at the time t uses the electric power amount W_{B}i(t−Δt) before charging and discharging.

$${W}_{B} i ( t ) = {W}_{B} i ( t - Δ t ) - {P}_{B} ( t ) \cdot Δ t / 3 \; 600 \cdot Pi ( t ) / \sum Pi ( t ) \qquad ( 4 a )$$

It is calculated. Then, the ratio Rwi(t) of the electric energy generated by the respective power generation facilities i in the electric energy storage amount is calculated as follows.

$$Rwi ( t ) = {W}_{B} i ( t ) / \sum {W}_{B} i ( t ) \qquad ( 4 b )$$

It is calculated.

The amount of electric power W_{L}i(t) generated by each power generation facility i at the load usage amount at time t is supplied with electric power from the storage battery (P_{B}>0 or P_{B}=0) (when the storage battery is discharged).

W_{L}i(t)=(Pi(t)+P_{B}(t)·Rwi(t))·Δt/3600 (5a)

When the battery is supplied with power (P_{B}<0) (when the battery is charged),

$${W}_{L} i ( t ) = Pi ( t ) ( 1 + {P}_{B} ( t ) / \sum Pi ( t ) ) \cdot Δ t / 3600 \qquad ( 5 b )$$

It is given. Then, the ratio of the amount of electric power generated by each power generation facility i is

$${R}_{L} i ( t ) = {W}_{L} i ( t ) / \sum {W}_{L} i ( t ) \qquad ( 5 c )$$

It is given. In the case of calculating the ratio derived from the above-described power generation, the parameters necessary for the calculation are input from the respective facilities to the calculation device.

### Flow of Arithmetic Processing

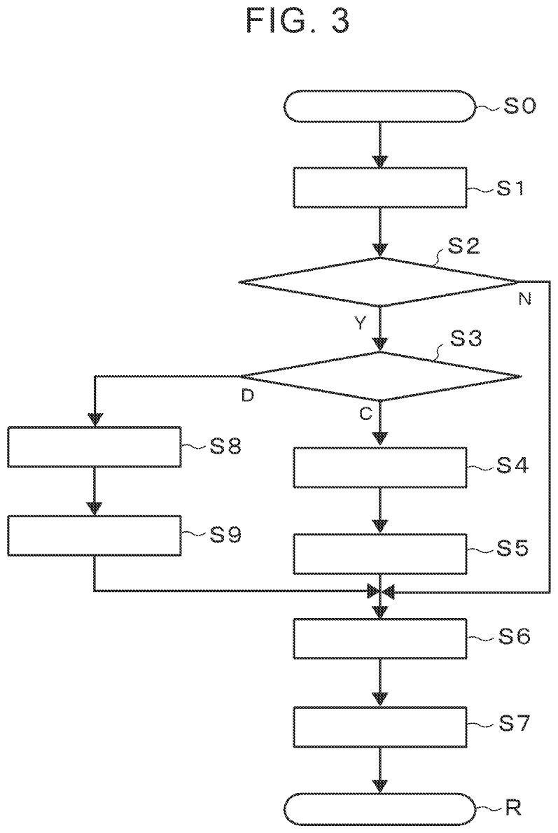

In the management system of the present embodiment, the above-described series of operations may be executed sequentially as illustrated in FIG. 3, for example. The process of FIG. 3 may be repeatedly executed at a predetermined cycle time that may be appropriately set. Specifically, first, when the calculation process is started (S0), a parameter required for the calculation is read (S1), and it may be determined whether or not the storage battery is connected to the power grid (S2). When the storage battery is not connected, the ratio of the power generation origin of the amount of electric power used in the load may be calculated using the above equations (5a) to (5c) (S6), and CO2 emission factor e_{L} of the load may be calculated using the equation (3) (S7).

When the storage battery is connected (S2), it is determined whether the storage battery is charged or discharged (S3). When charging is being performed, (C), the power generation origin of the storage amount and the ratio thereof may be calculated from the above equation (4a) to (4b) (S4), and CO2 emission factor e_{B} of the storage amount may be calculated (S5). On the other hand, when the storage battery is being discharged (D), the power generation origin of the storage amount and the ratio (S8), the storage amount after the discharge, and CO2 discharge amount, and the like may be respectively calculated using the above-described equations (S9). Then, a series of calculation results may be displayed on the display unit 12 or used to control the operation of each facility in an arbitrary power grid.

### Application of Arithmetic Processing

Basically, the series of arithmetic processing of the present embodiment is processing for calculating, in real time, CO2 emission factor of the storage battery, CO2 emission factor of the load, or the power generation derivation ratio of the amount of electricity stored or the amount of electric power used, and when the future CO2 emission factor of the respective power generation facilities can be detected, the series of arithmetic processing may be used for calculating CO2 emission factor of the storage battery, CO2 emission factor of the load, or the power generation derivation ratio of the amount of electricity stored or the amount of electric power used in the future. For example, when CO2 emission factor and the output power of the power generation facility can be predicted depending on the time zone, the series of calculations described above can be performed using the values, and the predicted value of CO2 emission factor of the storage battery can be calculated. Further, if such a predicted value is grasped, it is convenient when creating a future power supply-and-demand control plan.

In addition, since CO2 emission factor of the storage battery can be calculated, it is easy to appropriately control the charging time and the charging quantity so that CO2 emission factor of the storage battery is further lowered. For example, in the future, when it can be predicted that a power generation facility having a low CO2 emission factor is available, the storage capacity of the storage battery may be controlled so that the charging time of the storage battery is set to a time when the power generation facility having a low CO2 emission factor is available. In this regard, it may be contemplated to reduce CO2 emission factor of the storage battery by, for example, referencing solar radiation information or the like that can predict the amount of solar power generated so as to charge the electric power generated by the photovoltaic power generation facility having a CO2 emission factor of substantially 0.

While the foregoing description has been made in connection with embodiments of the disclosure, it will be apparent to those skilled in the art that many modifications and variations are readily possible, and that the disclosure is not limited to the embodiments illustrated above, but may be applied to various devices without departing from the spirit of the disclosure.

What is claimed is:

1. A management system of a power grid in which a plurality of power generation facilities, a storage battery that is able to store electric power generated by the power generation facilities, and a load that is able to use electric power from the power generation facilities and the storage battery are connected, the management system comprising a storage battery CO2 emission factor unit that calculates a CO2 emission factor of the storage battery, wherein the storage battery CO2 emission factor unit is configured to calculate the CO2 emission factor of the storage battery based on a CO2 emission factor of each of power generation facilities, among the power generation facilities, that generates the electric power charged in the storage battery, and an amount of the electric power charged in the storage battery from each of the power generation facilities.

2. The management system according to claim 1, wherein the CO2 emission factor of the storage battery is a value obtained by dividing a sum of multiplication values by a sum of the amounts of the electric power charged in the storage battery from the respective power generation facilities, among the power generation facilities, that generate the electric power charged in the storage battery, the multiplication values being each obtained by multiplying the CO2 emission factor of each of the power generation facilities, among the power generation facilities, that generates the electric power charged in the storage battery by the amount of the electric power charged in the storage battery from each of the power generation facilities.

3. The management system according to claim 1, further comprising a load CO2 emission factor unit that calculates a CO2 emission factor of the load, wherein the load CO2 emission factor unit is configured to calculate the CO2 emission factor of the load based on the CO2 emission factor of each of power generation facilities, among the power generation facilities, that supplies electric power to the load, an amount of the electric power supplied to the load from each of the power generation facilities, the CO2 emission factor of the storage battery, and an amount of electric power supplied to the load from the storage battery.

4. The management system according to claim 1, wherein the storage battery is a storage battery mounted on a vehicle that is selectively connected to the power grid.

5. A calculation device that is a storage battery CO2 emission factor calculation device that calculates a CO2 emission factor of a storage battery that stores electric power generated by a plurality of power generation facilities, wherein the device is configured to calculate the CO2 emission factor of the storage battery based on a CO2 emission factor of each of the power generation facilities and an amount of electric power charged in the storage battery.
